(19) United States
(12) Patent Application Publication
(10) Pub. No.: US 2026/0103003 A1
(43) Pub. Date: Apr. 16, 2026

(54) IMAGE FORMING APPARATUS AND INK SUPPLY METHOD CAPABLE OF PREVENTING TEMPERATURE OF HEATED INK SUPPLIED TO STORAGE PORTION FROM FALLING BELOW TARGET TEMPERATURE

(71) Applicant: KYOCERA Document Solutions Inc., Osaka (JP)

(72) Inventors: Takuma Araki, Osaka (JP); Yuna Niimi, Osaka (JP)

(21) Appl. No.: 19/325,244

(22) Filed: Sep. 10, 2025

(30) Foreign Application Priority Data
Sep. 24, 2024 (JP) 2024-164857

(51) Int. Cl. B41J 2/175; B41J 2/17; B41J 2/195; B41J 29/46

(52) U.S. Cl. CPC B41J 2/175; B41J 2/1707; B41J 2/195; B41J 29/46

(57) ABSTRACT

An image forming apparatus includes an ejection portion, a container portion, a storage portion, a heater, a detection processing portion, and a supply processing portion. The ejection portion ejects ink. The container portion contains the ink to be supplied to the ejection portion. The storage portion stores the ink between the container portion and the ejection portion in a supply path of the ink from the container portion to the ejection portion. The heater heats the ink between the container portion and the storage portion in the supply path; The detection processing portion detects temperature of a location where the image forming apparatus is installed. The supply processing portion supplies the ink from the container portion to the storage portion at a supply speed based on the detected temperature detected by the detection processing portion.

### INCORPORATION BY REFERENCE

This application is based upon and claims the benefit of priority from the corresponding Japanese Patent Application No. 2024-164857 filed on Sep. 24, 2024, the entire contents of which are incorporated herein by reference.

### BACKGROUND

The present disclosure relates to an image forming apparatus and an ink supply method.

An inkjet type image forming apparatus that includes an ejection portion, a container portion, and a storage portion is known. The ejection portion ejects ink. The container portion contains the ink to be supplied to the ejection portion. The storage portion stores the ink between the container portion and the ejection portion in a supply path of the ink from the container portion to the ejection portion.

In addition, an image forming apparatus is known in which a heater is provided between the container portion and the storage portion in the supply path to heat the ink to a target temperature.

### SUMMARY

An image forming apparatus according to an aspect of the present disclosure includes an ejection portion, a container portion, a storage portion, a heater, a detection processing portion, and a supply processing portion. The ejection portion ejects ink. The container portion contains the ink to be supplied to the ejection portion. The storage portion stores the ink between the container portion and the ejection portion in a supply path of the ink from the container portion to the ejection portion. The heater heats the ink between the container portion and the storage portion in the supply path. The detection processing portion detects temperature of a location where the image forming apparatus is installed. The supply processing portion supplies the ink from the container portion to the storage portion at a supply speed based on the detected temperature detected by the detection processing portion.

An ink supply method according to another aspect of the present disclosure is executed by an image forming apparatus that includes: an ejection portion configured to eject ink; a container portion configured to contain the ink to be supplied to the ejection portion; a storage portion configured to store the ink between the container portion and the ejection portion in a supply path of the ink from the container portion to the ejection portion; and a heater configured to heat the ink between the container portion and the storage portion in the supply path; and the ink supply method includes a detection step and a supply step. In the detection step, temperature of a location where the image forming apparatus is installed is detected. In the supply step, the ink is supplied from the container portion to the storage portion at a supply speed based on the detected temperature detected in the detection step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus of an embodiment according to the present disclosure.

FIG. 2 is a diagram illustrating a configuration of an image forming portion and a conveying unit of the image forming apparatus of an embodiment according to the present disclosure.

FIG. 3 is a block diagram showing a system configuration of an image forming apparatus of an embodiment according to the present disclosure.

FIG. 4 is a diagram showing a configuration of an ink supply portion and an ink recovery portion of an image forming apparatus of an embodiment according to the present disclosure.

FIG. 5 is a diagram showing a configuration of a heating device of an image forming apparatus of an embodiment according to the present disclosure.

FIG. 6 is a flowchart showing an example of a first supply process executed in an image forming apparatus of an embodiment according to the present disclosure.

FIG. 7 is a flowchart showing an example of a second supply process executed in an image forming apparatus of an embodiment according to the present disclosure.

### DETAILED DESCRIPTION

Hereinafter, embodiments according to the present disclosure will be described with reference to the accompanying drawings. Note that the following embodiments are examples according to the present disclosure and do not limit the technical scope of the present disclosure.

### [Configuration of Image Forming Apparatus 100]

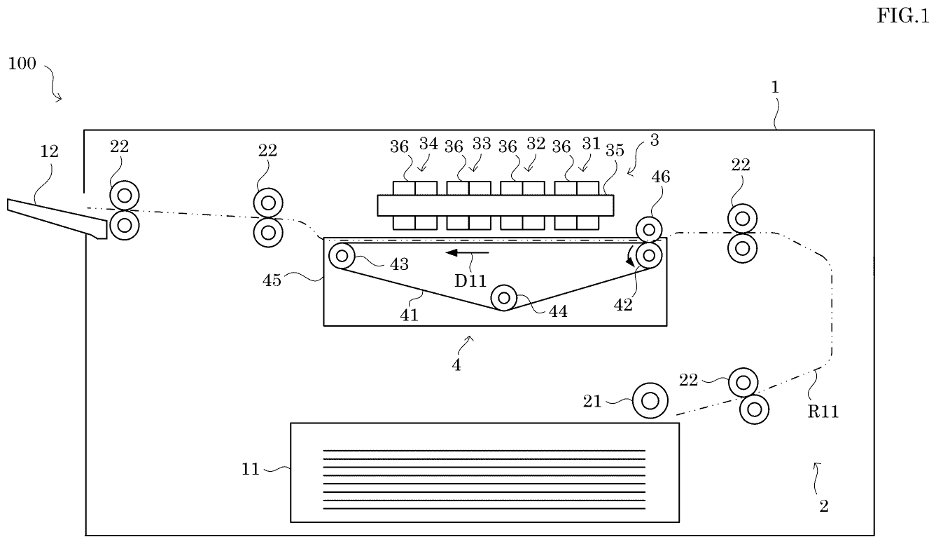

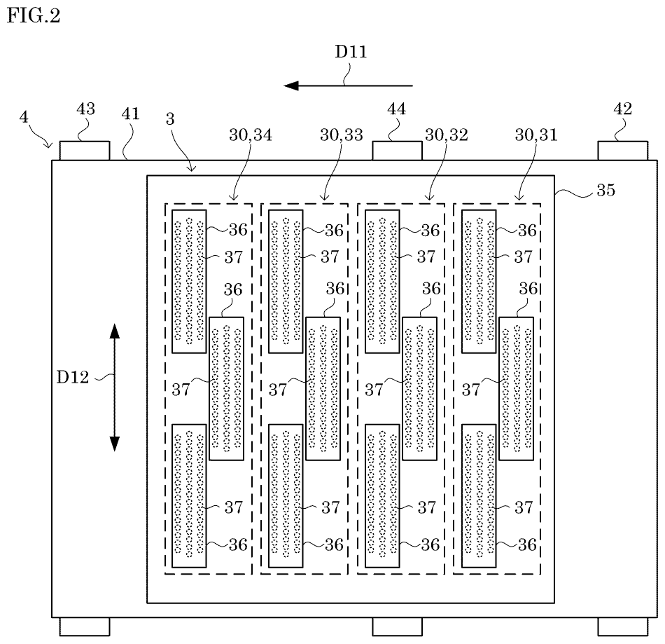

First, a configuration of an image forming apparatus 100 of an embodiment according to the present disclosure will be described with reference to FIGS. 1 to 3. Here, FIG. 1 is a cross-sectional view showing a configuration of the image forming apparatus 100. In addition, FIG. 2 is a plan view showing a configuration of an image forming portion 3 and a conveying unit 4. Note that in FIG. 1, a sheet conveying path R11 is indicated by a two-dot chain line.

The image forming apparatus 100 is a printer capable of forming an image on a sheet by an inkjet method. Note that the technique according to the present disclosure may be applied to image forming apparatuses such as fax machines, copy machines, and multifunction peripherals that are capable of forming images on sheets by an inkjet method.

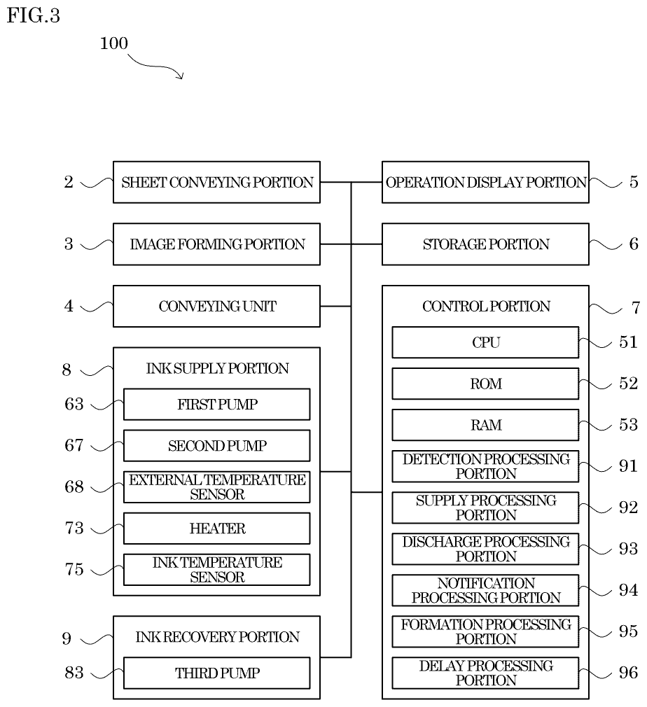

As shown in FIGS. 1 and 3, the image forming apparatus 100 includes a housing 1, a sheet conveying portion 2, an image forming portion 3, a conveying unit 4, an operation display portion 5, a storage portion 6, a control portion 7, an ink supply portion 8, and an ink recovery portion 9.

The housing 1 houses each of the components of the image forming apparatus 100. A sheet feed cassette 11 is detachably provided in the housing 1. The sheet feed cassette 11 stores sheets on which images are to be formed. A sheet discharge tray 12 is provided on an outer surface of the housing 1. A sheet on which an image has been formed by the image forming portion 3 is discharged to the sheet discharge tray 12. Inside the housing 1, sheets stored in the sheet feed cassette 11 are conveyed along a sheet conveying path R11 (see FIG. 1) that leads to the sheet discharge tray 12 via an image forming position of the image forming portion 3.

The sheet conveying portion 2 conveys the sheets stored in the sheet feed cassette 11 along the sheet conveying path R11 (see FIG. 1). As shown in FIG. 1, the sheet conveying portion 2 includes a pickup roller 21 and a plurality of conveying rollers 22. The pickup roller 21 picks up the top sheet of the sheets stack stored in the sheet feed cassette 11, and feeds the sheet out to the sheet conveying path R11. The plurality of conveying rollers 22 are provided side by side along the sheet conveying path R11. Each of the conveying rollers 22 conveys the sheet along the sheet conveying path R11. Each of the conveying rollers 22 conveys the sheet in the conveying direction D11 (see FIG. 1) from the sheet feed cassette 11 to the sheet discharge tray 12.

The image forming portion 3 forms an image on the sheet fed from the sheet conveying portion 2 based on image data. As shown in FIG. 1, the image forming portion 3 includes four line heads 30 (line heads 31 to 34) and a head frame 35.

As shown in FIG. 2, each of the line heads 30 is elongated in a width direction D12 perpendicular to the conveying direction D11. More specifically, each line head 30 has a length in the width direction D12 that corresponds to the width of the largest size sheet that can be stored in the sheet feed cassette 11. The four line heads 30 are provided side by side at equal intervals along the conveying direction D11.

As shown in FIG. 2, each line head 30 has a plurality of recording heads 36. The recording head 36 ejects ink toward the sheet conveyed by the conveying unit 4. More specifically, a large number of nozzles 37 (see FIG. 2) used for ejecting the ink are provided on a surface of the recording head 36 facing the sheet.

Each of the line heads 30 ejects the ink. More specifically, the line head 31 ejects black ink. In addition, the line head 32 ejects cyan ink. Moreover, the line head 33 ejects magenta ink. Further, the line head 34 ejects yellow ink. The line head 30 is an example of an ejection portion according to the present disclosure.

In the present embodiment, the line head 31 has three recording heads 36 arranged in a staggered manner along the width direction D12. In addition, similarly to the line head 31, each of the other line heads 32 to 34 has three recording heads 36 arranged in a staggered manner along the width direction D12. Note that the image forming portion 3 as viewed from above is shown in FIG. 2.

The head frame 35 supports the four line heads 30. The head frame 35 is supported by the housing 1. Note that the number of line heads 30 provided in the image forming portion 3 may be one or more. In addition, the number of recording heads 36 provided in each line head 30 does not need to be limited to three.

As shown in FIG. 1, the conveying unit 4 is arranged below the four line heads 30. The conveying unit 4 conveys the sheet while facing the line head 30. For example, the conveying unit 4 conveys the sheet by a predetermined conveying amount every time the line head 30 ejects the ink. In addition, the conveying unit 4 stops conveying the sheet while the line head 30 is ejecting the ink. As shown in FIG. 1, the conveying unit 4 includes a conveying belt 41 on which a sheet is placed, a first tension roller 42, a second tension roller 43, and a third tension roller 44 that tension the conveying belt 41, and a conveying frame 45 that supports these. Note that a gap between the conveying belt 41 and the recording head 36 is adjusted so that a gap between the surface of the sheet and the recording heads 36 during image formation is a predetermined distance (for example, 1 mm).

The first tension roller 42 is rotationally driven by a rotational driving force supplied from a motor (not shown). Thus, the conveying belt 41 rotates in a direction capable of conveying the sheet in a conveying direction D11 (see FIG. 1). The conveying unit 4 is also provided with a suction unit (not shown) that sucks air from a large number of through holes formed in the conveying belt 41 in order to attach the sheet to the conveying belt 41. In addition, a pressure roller 46 is provided above the first tension roller 42 in order to press the sheet against the conveying belt 41 for conveying.

The operation display portion 5 is a user interface of the image forming apparatus 100. The operation display portion 5 includes a display portion and an operation portion. The display portion displays various types of information in response to control instructions from the control portion 7. For example, the display portion is a liquid crystal display. The operation portion inputs various types of information to the control portion 7 in response to operations by a user. For example, the operation portion is a touch panel. The operation display portion 5 is provided on a top surface of the housing 1.

The storage portion 6 is a non-volatile storage device. For example, the storage portion 6 is a non-volatile memory such as a flash memory. The storage portion 6 may be a solid state drive (SSD) or a hard disk drive (HDD).

The control portion 7 performs overall control of the image forming apparatus 100. As shown in FIG. 3, the control portion 7 includes a CPU 51, a ROM 52, and a RAM 53. The CPU 51 is a processor that executes various types of arithmetic processes. The ROM 52 is a non-volatile storage device in which information such as control programs for causing the CPU 51 to execute various types of processes is stored in advance. The RAM 53 is a volatile or non-volatile storage device used as a temporary storage memory (work area) for various types of processes executed by the CPU 51. The CPU 51 performs overall control of the image forming apparatus 100 by executing various types of control programs prestored in the ROM 52. Note that the control portion 7 may be a control portion provided separately from a main control portion that performs overall control of the image forming apparatus 100. In addition, the control portion 7 may also be configured with an electronic circuit such as an application specific integrated circuit (ASIC).

### [Configuration of Ink Supply Portion 8 and Ink Recovery Portion 9]

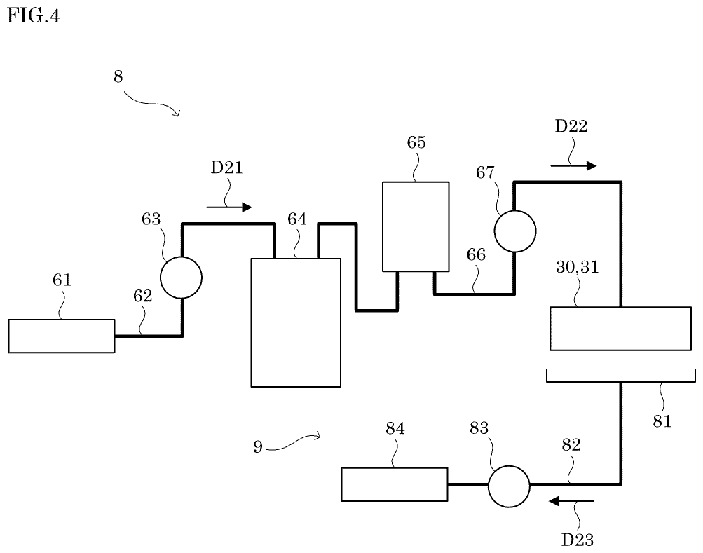

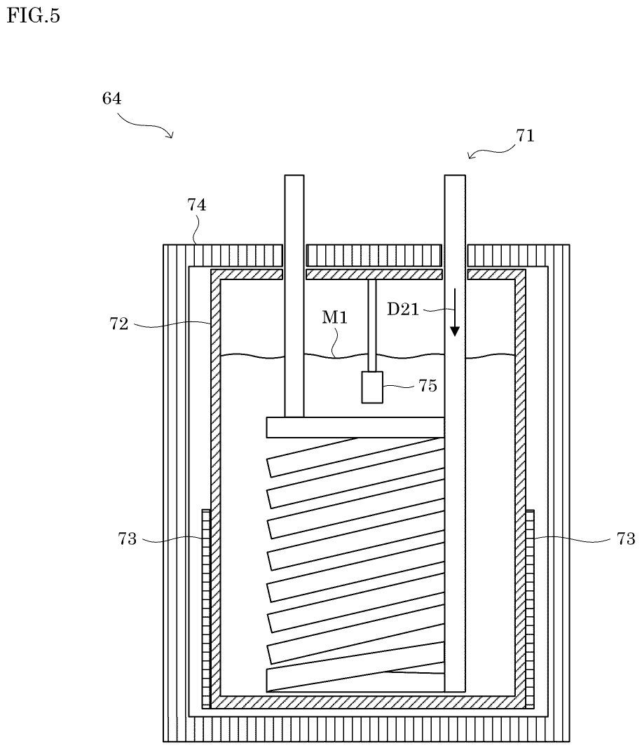

Next, configurations of the ink supply portion 8 and the ink recovery portion 9 will be described with reference to FIGS. 3 to 5. Here, FIG. 4 is a schematic diagram showing a configuration of the ink supply portion 8 and the ink recovery portion 9 corresponding to the line head 31. In addition, FIG. 5 is a cross-sectional view showing a configuration of the heating device 64 corresponding to the line head 31. Note that in FIG. 4, a first supply flow path 62, a second supply flow path 66, and a recovery flow path 82 are indicated by thick lines.

The ink supply portion 8 supplies the ink to the line head 30. An ink supply portion 8 is provided for each line head 30. Note that the configurations of the four ink supply portions 8 corresponding to the four line heads 30 are the same except that the colors of the inks supplied are different.

As shown in FIGS. 3 and 4, the ink supply portion 8 includes an ink container 61, the first supply flow path 62, a first pump 63, a heating device 64, a sub-ink tank 65, the second supply flow path 66, a second pump 67, and an external temperature sensor 68.

The ink container 61 stores the ink to be supplied to the line head 30. For example, the ink is a water-based ink in which the main solvent is water. Note that the ink may be a non-aqueous ink whose main solvent is an organic solvent. The ink container 61 is an example of a storage portion according to the present disclosure.

The first supply flow path 62 is an ink flow path provided between the ink container 61 and the sub-ink tank 65. The first supply flow path 62 is made of a flexible material. For example, the first supply flow path 62 is a tube made of resin.

The first pump 63 forms a part of the first supply flow path 62. The first pump 63 causes the ink in the first supply flow path 62 to flow in a first flow direction D21 (see FIG. 4) toward the line head 30. For example, the first pump 63 is a syringe pump.

The heating device 64 forms part of the first supply flow path 62. The heating device 64 heats the ink flowing through the first supply flow path 62.

As shown in FIG. 5, the heating device 64 includes a coil tube 71, a container 72, a heater 73, a heat insulating material 74, and an ink temperature sensor 75.

The coil tube 71 is a tube formed in a spiral shape. The coil tube 71 is arranged with a spiral axis thereof aligned vertically. For example, the coil tube 71 is formed by processing a straight metal tube into a spiral shape. The coil tube 71 forms a part of the first supply flow path 62.

The container 72 contains the coil tube 71 and a liquid heat transfer medium M1 (see FIG. 5) used to heat the coil tube 71. For example, the container 72 includes a cylindrical portion extending along the vertical direction, a disk-shaped bottom portion closing a lower end of the cylindrical portion, and a disk-shaped top portion closing an upper end of the cylindrical portion.

An inner portion of the container 72 is filled with the heat transfer medium M1 (see FIG. 5) in an amount sufficient to submerge a spiral portion of the coil tube 71 that is formed in a spiral shape. For example, the heat transfer medium M1 is water. Note that the heat transfer medium M1 is not limited to water, but may be a fluid such as oil.

The heater 73 heats the container 72. More specifically, the heater 73 is a so-called planar heater. For example, the heater 73 includes a heating wire and a metal sheet, such as aluminum, that covers the heating wire. The heater 73 is provided to cover an outer surface of the container 72. In the heating device 64, the container 72 is heated by the heater 73, and the heat transfer medium M1 contained in the container 72 is thereby heated. Thus, the ink flowing inside the spiral portion arranged within the heat transfer medium M1 is heated to the same temperature as the heat transfer medium M1.

The heat insulating material 74 is provided so as to cover an outer peripheral surface of the container 72. The heater 73 is provided between the container 72 and the heat insulating material 74. For example, the heat insulating material 74 is provided so as to cover the entire outer surface of the container 72.

The ink temperature sensor 75 is used to detect temperature of the ink heated by the heating device 64. For example, the ink temperature sensor 75 is a contact type temperature sensor that is provided in contact with the heat transfer medium M1. The ink temperature sensor 75 outputs a first detection signal including a signal value according to the temperature of the heat transfer medium M1 in contact with the ink temperature sensor 75. The first detection signal output from the ink temperature sensor 75 is input to the control portion 7. Based on the first detection signal input from the ink temperature sensor 75, the control portion 7 controls the driving of the heater 73 so that the temperature of the heat transfer medium M1 becomes a predetermined target temperature.

Note that the heating device 64 may be configured to heat the ink without using the heat transfer medium M1. For example, the heating device 64 may be configured to include a metal ink flow path and a heater 73 that directly heats the ink flow path.

The sub-ink tank 65 stores the ink supplied from the ink container 61. The ink stored in the sub-ink tank 65 is supplied to the line head 30.

The second supply flow path 66 is an ink flow path provided between the sub-ink tank 65 and the line head 30. The second supply flow path 66 is formed from a flexible material. For example, the second supply flow path 66 is a tube made of resin.

The second pump 67 forms part of the second supply flow path 66. The second pump 67 causes the ink in the second supply flow path 66 to flow in a second flow direction D22 (see FIG. 4). For example, the second pump 67 is a syringe pump.

The external temperature sensor 68 detects air temperature outside the housing 1 (external temperature). The external temperature sensor 68 is provided outside the housing 1. The external temperature sensor 68 outputs a second detection signal including a signal value corresponding to the air temperature outside the housing 1. The second detection signal output from the external temperature sensor 68 is input to the control portion 7.

The first supply flow path 62 and the second supply flow path 66 form a supply path of the ink from the ink container 61 to the line head 30. The heater 73 of the heating device 64 heats the ink between the ink container 61 and the sub-ink tank 65 in the supply path. The sub-ink tank 65 stores the ink between the ink container 61 and the line head 30 in the supply path. The sub-ink tank 65 is an example of a storage portion according to the present disclosure.

The ink recovery portion 9 recovers the ink (waste ink) ejected by the line head 30. An ink recovery portion 9 is provided for each line head 30. Note that the four ink recovery portions 9 corresponding to the four line heads 30 have the same configuration, except that the colors of the inks recovered are different.

As shown in FIGS. 3 and 4, the ink recovery portion 9 includes an ink receiving portion 81, a recovery flow path 82, a third pump 83, and a waste ink container portion 84.

The ink receiving portion 81 receives the waste ink ejected by the line head 30. The ink receiving portion 81 is provided so as to be movable between an opposing position facing the line head 30 below the line head 30 and a retreat position retreated horizontally from the opposing position. In a case in which an image is formed on a sheet, the ink receiving portion 81 is moved to the retreat position.

The recovery flow path 82 is an ink flow path provided between the ink receiving portion 81 and the waste ink container portion 84. The recovery flow path 82 is made of a flexible material. For example, the recovery flow path 82 is a tube made of resin.

The third pump 83 forms a part of the recovery flow path 82. The third pump 83 causes the waste ink in the recovery flow path 82 to flow in a third flow direction D23 (see FIG. 4). For example, the third pump 83 is a syringe pump.

The waste ink container portion 84 stores the waste ink ejected by the line head 30.

In a conventional image forming apparatus, in a case in which the ink contained in the ink container 61 is cold, the temperature of the ink supplied to the sub-ink tank 65 after being heated by the heater 73 may fall below the target temperature.

In contrast, in the image forming apparatus 100 of an embodiment according to the present disclosure, as will be described below, it is possible to prevent the temperature of the heated ink supplied to the sub-ink tank 65 from falling below the target temperature.

### [Configuration of Control Portion 7]

Next, a configuration of the control portion 7 will be described in more detail with reference to FIG. 3.

As shown in FIG. 3, the control portion 7 includes a detection processing portion 91, a supply processing portion 92, a discharge processing portion 93, a notification processing portion 94, a formation processing portion 95, and a delay processing portion 96.

More specifically, the ROM 52 of the control portion 7 stores in advance an operation control program for causing the CPU 51 to function as each of the above-mentioned processing portions. The CPU 51, by executing the operation control program stored in the ROM 52, functions as each of the above-mentioned processing portions.

Note that the operation control program may be recorded on a computer-readable recording medium such as a CD, DVD, or flash memory, and may be read from the recording medium and stored in a storage device such as the storage portion 6. In addition, a part or all of the above-mentioned processing portions may be configured with an electronic circuit such as an application specific integrated circuit (ASIC). Further, the operation control program may be a program for causing a plurality of processors to function as each processing portion included in the control portion 7.

The detection processing portion 91 detects temperature of the location where the image forming apparatus 100 is installed.

For example, the detection processing portion 91 detects the external temperature using the external temperature sensor 68. That is, the detection processing portion 91 acquires the external temperature corresponding to the first detection signal output from the external temperature sensor 68 as the temperature of the location where the image forming apparatus 100 is installed. Note that the detection processing portion 91 may detect the temperature inside the housing 1 as the temperature of the location where the image forming apparatus 100 is installed.

The supply processing portion 92 supplies the ink from the ink container 61 to the sub-ink tank 65 at a supply speed based on the detected temperature detected by the detection processing portion 91.

More specifically, when the detected temperature is equal to or higher than a predetermined reference temperature, the supply processing portion 92 supplies the ink from the ink container 61 to the sub-ink tank 65 at a predetermined first supply speed. In addition, in a case in which the detected temperature is lower than the reference temperature, the supply processing portion 92 supplies the ink from the ink container 61 to the sub-ink tank 65 at a second supply speed that is slower than the first supply speed.

For example, in a case in which the detected temperature is lower than the reference temperature, the supply processing portion 92 supplies the ink from the ink container 61 to the sub-ink tank 65 at the second supply speed based on the detected temperature.

For example, the first supply speed is the same as a consumption speed of the ink when a monochrome image having a printing rate of 100% is formed on a sheet.

In addition, the reference temperature is set so that when the temperature of the ink in the ink container 61 is lower than the reference temperature, the temperature of the ink passing through the heating device 64 at the first supply speed falls below the target temperature, and when the temperature of the ink in the ink container 61 is higher than the reference temperature, the temperature of the ink passing through the heating device 64 at the first supply speed becomes the target temperature.

In addition, the second supply speed is calculated according to the following Formula (1). Note that “V2” included in Formula (1) represents the second supply speed (mL/sec). In addition, “V1” included in Formula (1) represents the first supply speed (mL/sec). Moreover, “Tc” included in Formula (1) represents the detection temperature (C). Further, “T1” included in Formula (1) represents the reference temperature (° C.).

$$V 2 = V 1 \times Tc \div T 1 \qquad ( 1 )$$

The supply processing portion 92 drives the first pump 63 so that the ink is supplied from the ink container 61 to the sub-ink tank 65 at the supply speed.

Note that first table data indicating a correspondence relationship between the detected temperature and the second supply speed may be stored in the storage portion 6 in advance. The first table data may define a correspondence relationship between the detected temperature and the second supply speed such that the second supply speed becomes slower as the detected temperature becomes lower. In a case in which the first table data is stored in the storage portion 6, the second supply speed may be obtained by using the first table data.

In addition, the second supply speed may be a predetermined constant value.

In addition, in a case in which the detected temperature is equal to or higher than the reference temperature, the supply processing portion 92 may obtain the first supply speed based on the detected temperature. In other words, the first supply speed does not have to be a predetermined constant value.

The discharge processing portion 93 executes a discharge process for discharging the ink stored in the sub-ink tank 65.

For example, the discharge processing portion 93 executes the discharge process when the image forming apparatus 100 is powered on. In addition, the discharge processing portion 93 executes the discharge process when the operation mode of the image forming apparatus 100 transitions from a power saving mode in which power consumption is reduced more than in the normal mode to the normal mode. The discharge processing portion 93 may execute the discharge process when a predetermined operation is received on the operation display portion 5.

For example, in the discharge process, the second pump 67 is used to discharge the ink from the line head 30 to the ink receiving portion 81 until the ink remaining in the sub-ink tank 65 runs out. In addition, in the discharge process, the third pump 83 is used to send the waste ink discharged into the ink receiving portion 81 to the waste ink container portion 84.

Here, after the discharge process is executed, the supply processing portion 92 supplies the ink from the ink container 61 to the sub-ink tank 65 until the remaining amount of the ink in the sub-ink tank 65 reaches a predetermined second amount.

For example, the second amount is the same as the remaining amount of ink in the sub-ink tank 65 when the sub-ink tank 65 is full.

For example, the ink supply portion 8 includes a remaining amount detection sensor (not shown) capable of detecting the remaining amount of ink in the sub-ink tank 65.

The supply processing portion 92 supplies the ink from the ink container 61 to the sub-ink tank 65 until the remaining amount of ink in the sub-ink tank 65 detected by the remaining amount detection sensor reaches the second amount.

When the ink is supplied by the supply processing portion 92 after the discharge process is executed and the supply of the ink does not end before the elapsed time from the start of the supply of the ink by the supply processing portion 92 exceeds an allowable time corresponding to the supply speed, the notification processing portion 94 notifies the user that.

For example, the allowable time is calculated according to the following Formula (2). Note that “A” included in Formula (2) indicates the allowable time (sec). In addition, “B” included in Formula (2) represents the second amount (mL). Further, “V” in formula (2) represents the supply speed (mL/sec).

$$A = B \div V \qquad ( 2 )$$

For example, in a case in which the supply of the ink is not completed before the elapsed time from the start of the supply of the ink by the supply processing portion 92 exceeds the allowable time, the notification processing portion 94 displays a message on the operation display portion 5 indicating that there is an abnormality in the ink supply portion 8.

Note that second table data indicating the correspondence relationship between the supply speed and the allowable time may be stored in the storage portion 6 in advance. In the second table data, it is only necessary that a correspondence relationship between the supply speed and the allowable time is defined such that the slower the supply speed is, the longer the allowable time is. When the second table data is stored in the storage portion 6, the allowable time may be obtained by using the second table data.

The formation processing portion 95 executes a formation process for forming an image on a sheet using the line head 30.

Here, the supply processing portion 92 supplies the ink from the ink container 61 to the sub-ink tank 65 in a case in which the remaining amount of the ink in the sub-ink tank 65 is less than a predetermined first amount during execution of the formation process.

The first amount is less than the second amount.

For example, in a case in which the remaining amount of ink in the sub-ink tank 65 detected by the remaining amount detection sensor during execution of the formation process is less than the first amount, the supply processing portion 92 supplies the ink from the ink container 61 to the sub-ink tank 65 until the remaining amount reaches a third amount that is greater than the first amount and less than the second amount.

The delay processing portion 96 delays the formation of an image when the printing rate of an image formed on a sheet while the ink is being supplied at the second supply speed by the supply processing portion 92 exceeds a threshold value corresponding to the second supply speed.

For example, the threshold value is calculated according to the following Formula (3). Note that “C” included in Formula (3) represents the threshold value (%). In addition, “V2” included in Formula (3) represents the second supply speed (mL/sec). Further, “V1” included in Formula (3) represents the first supply speed (mL/sec).

$$C = ( V 2 \div V 1 ) \times 100 \qquad ( 3 )$$

For example, in a case in which the printing rate of an image formed on a sheet while the ink is being supplied by the supply processing portion 92 at the second supply speed exceeds the threshold value corresponding to the second supply speed, the delay processing portion 96 delays the formation of the image until the supply of the ink by the supply processing portion 92 is completed. The printing rate of an image formed on a sheet may be obtained based on image data used to form the image.

Note that third table data indicating the correspondence relationship between the second supply speed and the threshold value may be stored in the storage portion 6 in advance. In the third table data, it is only necessary that a correspondence relationship between the second supply speed and the threshold value is defined such that the threshold value becomes smaller as the second supply speed becomes slower. In a case in which the third table data is stored in the storage portion 6, the threshold value may be obtained by using the third table data.

Hereinafter, an ink supply method according to the present disclosure will be described along with an example of a procedure of each process executed by the control portion 7.

### [First Supply Process]

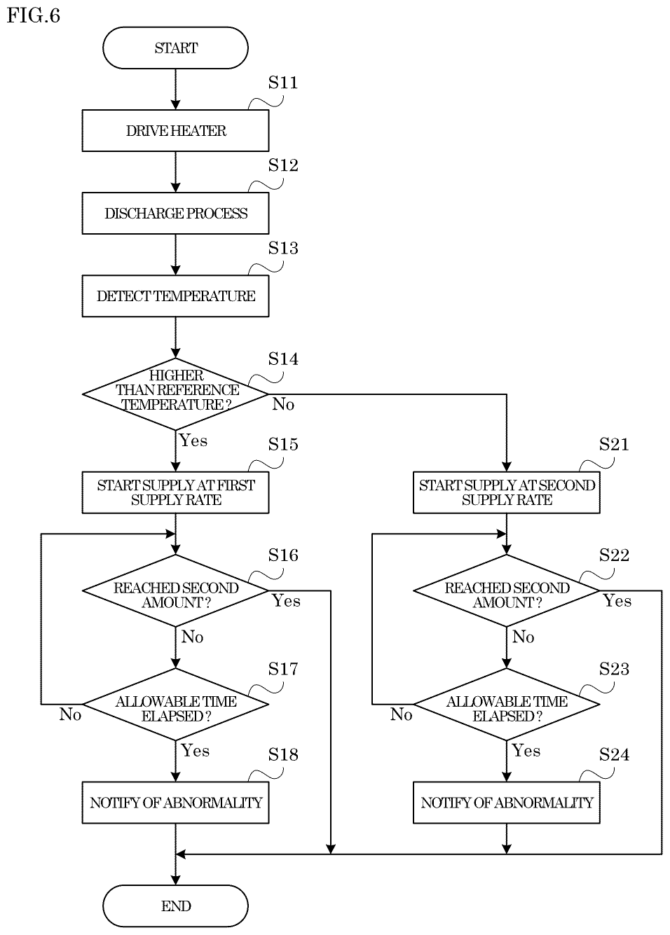

Hereinafter, an example of a procedure of the first supply process executed by the control portion 7 in the image forming apparatus 100 will be described with reference to FIG. 6. Here, steps S11, S12, and so on represent numbers of processing procedures (steps) executed by the control portion 7. Note that the first supply process is executed when the image forming apparatus 100 is powered on. In addition, the first supply process is executed when the operation mode of the image forming apparatus 100 transitions from the power saving mode to the normal mode.

The first supply process is executed for each ink supply portion 8 corresponding to each line head 30.

### <Step S11>

First, in step S11, the control portion 7 drives the heater 73.

More specifically, the control portion 7 controls the driving of the heater 73 based on the first detection signal input from the ink temperature sensor 75 so that the temperature of the heat transfer medium M1 becomes the target temperature.

### <Step S12>

In step S12, the control portion 7 executes the discharge process. The process of step S12 is executed by the discharge processing portion 93 of the control portion 7.

### <Step S13>

In step S13, the control portion 7 detects the temperature of the location where the image forming apparatus 100 is installed. The process of step S13 is an example of a detection step according to the present disclosure, and is executed by the detection processing portion 91 of the control portion 7.

### <Step S14>

In step S14, the control portion 7 determines whether or not the detected temperature detected in the process of step S13 is equal to or higher than the reference temperature.

Here, when the control portion 7 determines that the detected temperature is equal to or higher than the reference temperature (YES in S14), the control portion 7 causes the process to proceed to step S15. In addition, when the detected temperature is not equal to or higher than the reference temperature (NO in S14), the control portion 7 causes the process to proceed to step S21.

### <Step S15>

In step S15, the control portion 7 starts supplying the ink from the ink container 61 to the sub-ink tank 65 at the first supply speed. The process of step S15 is an example of a supply step according to the present disclosure, and is executed by the supply processing portion 92 of the control portion 7.

### <Step S16>

In step S16, the control portion 7 determines whether or not the remaining amount of ink in the sub-ink tank 65 has reached the second amount.

Here, when the control portion 7 determines that the remaining amount of ink in the sub-ink tank 65 has reached the second amount (YES in S16), the control portion 7 stops the supply of ink to the sub-ink tank 65 and ends the first supply process. In addition, when the remaining amount of ink in the sub-ink tank 65 has not reached the second amount (NO in S16), the control portion 7 causes the process to proceed to step S17.

### <Step S17>

In step S17, the control portion 7 determines whether or not the elapsed time from the execution of the process in step S15 has exceeded the allowable time corresponding to the first supply speed.

Here, when the control portion 7 determines that the elapsed time from the execution of the process in step S15 has exceeded the allowable time corresponding to the first supply speed (YES in S17), the control portion 7 causes the process to proceed to step S18. In addition, when the elapsed time from the execution of the process in step S15 has not exceeded the allowable time corresponding to the first supply speed (NO in S17), the control portion 7 causes the process to proceed to step S16.

### <Step S18>

In step S18, the control portion 7 terminates the supply of ink to the sub-ink tank 65 and notifies the user that the supply of ink has not ended before the elapsed time from the start of the supply of ink exceeds the allowable time. The process of step S18 is executed by the notification processing portion 94 of the control portion 7.

For example, the control portion 7 causes the operation display portion 5 to display a message indicating that an abnormality has occurred in the ink supply portion 8.

### <Step S21>

In step S21, the control portion 7 starts supplying the ink from the ink container 61 to the sub-ink tank 65 at the second supply speed. The process of step S21 is an example of a supply step according to the present disclosure, and is executed by the supply processing portion 92 of the control portion 7.

### <Step S22>

In step S22, the control portion 7 determines whether or not the remaining amount of ink in the sub-ink tank 65 has reached the second amount.

Here, when the control portion 7 determines that the remaining amount of ink in the sub-ink tank 65 has reached the second amount (YES in S22), the control portion 7 stops the supply of ink to the sub-ink tank 65 and ends the first supply process. In addition, when the remaining amount of ink in the sub-ink tank 65 has not reached the second amount (NO in S22), the control portion 7 causes the process to proceed to step S23.

### <Step S23>

In step S23, the control portion 7 determines whether or not the elapsed time from the execution of the process in step S21 has exceeded the allowable time corresponding to the second supply speed.

Here, when the control portion 7 determines that the elapsed time from the execution of the process in step S21 exceeds the allowable time corresponding to the second supply speed (YES in S23), the control portion 7 causes the process to proceed to step S24. In addition, when the elapsed time from the execution of the process in step S21 has not exceeded the allowable time corresponding to the second supply speed (NO in S23), the control portion 7 causes the process to proceed to step S22.

### <Step S24>

In step S24, the control portion 7 terminates the supply of the ink to the sub-ink tank 65 and notifies the user that the supply of the ink has not ended before the elapsed time from the start of the supply of the ink exceeds the allowable time. The process of step S24 is executed by the notification processing portion 94 of the control portion 7.

For example, the control portion 7 causes the operation display portion 5 to display a message indicating that an abnormality has occurred in the ink supply portion 8.

### [Second Supply Process]

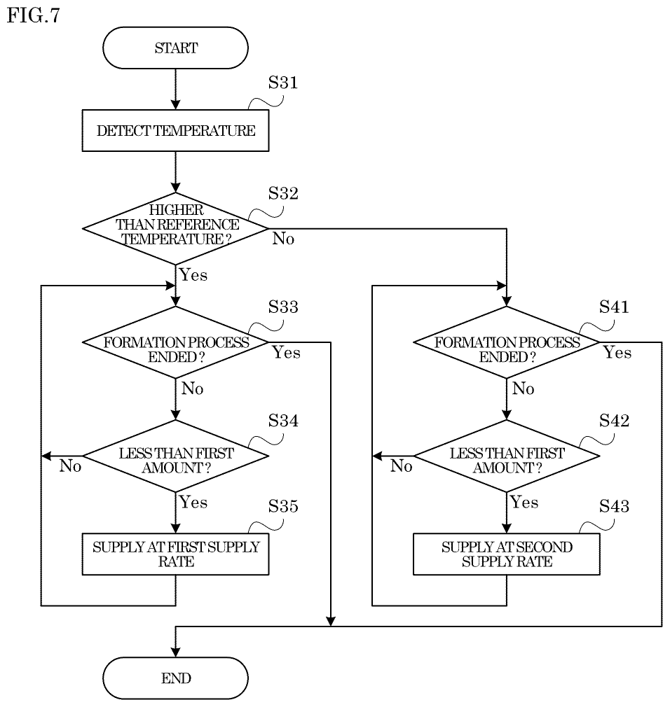

Next, an example of the procedure of the second supply process executed by the control portion 7 in the image forming apparatus 100 will be described with reference to FIG. 7. Note that the second supply process is executed together with the formation process when an instruction to execute the formation process is input.

The second supply process is executed for each ink supply portion 8 corresponding to each line head 30. In the following, of the four second supply processes, the second supply process corresponding to the line head 31 will be described.

### <Step S31>

First, in step S31, the control portion 7 detects the temperature of the location where the image forming apparatus 100 is installed. The process of step S31 is an example of a detection step according to the present disclosure, and is executed by the detection processing portion 91 of the control portion 7.

### <Step S32>

In step S32, the control portion 7 determines whether or not the detected temperature detected in the process of step S31 is equal to or higher than the reference temperature.

Here, when the control portion 7 determines that the detected temperature is equal to or higher than the reference temperature (YES in S32), the control portion 7 causes the process to proceed to step S33. In addition, when the detected temperature is not equal to or higher than the reference temperature (NO in S32), the control portion 7 causes the process to proceed to step S41.

Note that the temperature of the ink in the ink container 61 gradually rises from the temperature of the location where the image forming apparatus 100 is installed as time passes from the start of the first supply process. Therefore, even in a case in which the control portion 7 determines in the processing of step S32 that the detected temperature is lower than the reference temperature, in a case in which the elapsed time from the start of the first supply process exceeds a predetermined time, the control portion 7 may cause the process to proceed to step S33.

### <Step S33>

In step S33, the control portion 7 determines whether or not the formation process has been completed.

Here, when the control portion 7 determines that the formation process has ended (YES in S33), the control portion 7 ends the second supply process. In addition, when the formation process is not completed (NO in S33), the control portion 7 causes the process to proceed to step S34.

### <Step S34>

In step S34, the control portion 7 determines whether or not the remaining amount of ink in the sub-ink tank 65 is less than the first amount.

Here, when the control portion 7 determines that the remaining amount of ink in the sub-ink tank 65 is less than the first amount (YES in S34), the control portion 7 causes the process to proceed to step S35. In addition, when the remaining amount of ink in the sub-ink tank 65 is not less than the first amount (NO in S34), the control portion 7 causes the process to proceed to step S33.

### <Step S35>

In step S35, the control portion 7 supplies the ink from the ink container 61 to the sub-ink tank 65 at the first supply speed. The process of step S35 is an example of a supply step according to the present disclosure, and is executed by the supply processing portion 92 of the control portion 7.

More specifically, the control portion 7 supplies the ink from the ink container 61 to the sub-ink tank 65 until the remaining amount of the ink in the sub-ink tank 65 reaches the third amount.

### <Step S41>

In step S41, the control portion 7 determines whether or not the formation process has been completed.

Here, when the control portion 7 determines that the formation process has ended (YES in S41), the control portion 7 ends the second supply process. In addition, when the formation process is not completed (NO in S41), the control portion 7 causes the process to proceed to step S42.

### <Step S42>

In step S42, the control portion 7 determines whether or not the remaining amount of ink in the sub-ink tank 65 is less than the first amount.

Here, when the control portion 7 determines that the remaining amount of ink in the sub-ink tank 65 is less than the first amount (YES in S42), the control portion 7 causes the process to proceed to step S43. In addition, when the remaining amount of ink in the sub-ink tank 65 is not less than the first amount (NO in S42), the control portion 7 causes the process to proceed to step S41.

### <Step S43>

In step S43, the control portion 7 supplies the ink from the ink container 61 to the sub-ink tank 65 at the second supply speed. The process of step S43 is an example of a supply step according to the present disclosure, and is executed by the supply processing portion 92 of the control portion 7.

More specifically, the control portion 7 supplies the ink from the ink container 61 to the sub-ink tank 65 until the remaining amount of the ink in the sub-ink tank 65 reaches the third amount.

Here, in a case in which the printing rate of a black image formed on the sheet during the supply of the ink by the process of step S43 exceeds the threshold value corresponding to the second supply speed, the control portion 7 delays the formation of the image. Thus, it is possible to prevent the remaining amount of ink in the sub-ink tank 65 from decreasing excessively when the ink consumption speed exceeds the second supply speed.

In this manner, in the image forming apparatus 100, the speed at which the ink passes through the heating device 64 is controlled based on the detection result of the temperature of the location where the image forming apparatus 100 is installed. Thus, the lower the temperature of the ink contained in the ink container 61, the slower the speed at which the ink passes through the heating device 64 can be made, thereby lengthening the time for which the ink is heated. Therefore, it is possible to prevent the temperature of the heated ink supplied to the sub-ink tank 65 from falling below the target temperature.

### [Supplementary Notes]

An outline of the invention extracted from the above-described embodiments will be added below. The configurations and processing functions described in the following supplementary notes can be selected and combined as desired.

### <Supplementary Note 1>

An image forming apparatus, including:
an ejection portion configured to eject ink;
a container portion configured to contain the ink to be supplied to the ejection portion;
a storage portion configured to store the ink between the container portion and the ejection portion in a supply path of the ink from the container portion to the ejection portion;
a heater configured to heat the ink between the container portion and the storage portion in the supply path;
a detection processing portion configured to detect temperature of a location where the image forming apparatus is installed; and
a supply processing portion configured to supply the ink from the container portion to the storage portion at a supply speed based on the detected temperature detected by the detection processing portion.

### <Supplementary Note 2>

The image forming apparatus according to Supplementary Note 1, wherein
the supply processing portion supplies the ink from the container portion to the storage portion at a predetermined first supply speed when the detected temperature is equal to or higher than a predetermined reference temperature, and supplies the ink from the container portion to the storage portion at a second supply speed slower than the first supply speed when the detected temperature is lower than the reference temperature.

### <Supplementary Note 3>

The image forming apparatus according to Supplementary Note 2, wherein
the supply processing portion, when the detected temperature is lower than the reference temperature, supplies the ink from the container portion to the storage portion at the second supply speed based on the detected temperature.

### <Supplementary Note 4>

The image forming apparatus according to Supplementary Note 2 or Supplementary Note 3, including
a formation processing portion configured to execute a formation process for forming an image on a sheet by using the ejection portion; wherein
the supply processing portion supplies the ink from the container portion to the storage portion when the remaining amount of the ink in the storage portion is less than a predetermined first amount during execution of the formation process; and
the image forming apparatus includes a delay processing portion configured to delay formation of an image formed on the sheet when a printing rate of the image while the ink is being supplied at the second supply speed by the supply processing portion exceeds a threshold value corresponding to the second supply speed.

### <Supplementary Note 5>

The image forming apparatus according to any one of Supplementary Notes 1 to 4, including
a discharge processing portion configured to execute a discharge process for discharging the ink stored in the storage portion; wherein
the supply processing portion, after the discharge process is executed, supplies the ink from the container portion to the storage portion until the remaining amount of the ink in the storage portion reaches a predetermined second amount; and
the image forming apparatus includes a notification processing portion configured to, when supply of the ink by the supply processing portion will not end before the elapsed time from start of the supply exceeds an allowable time corresponding to the supply speed, notify that.

### <Supplementary Note 6>

An ink supply method executed by an image forming apparatus including: an ejection portion configured to eject ink; a container portion configured to contain the ink to be supplied to the ejection portion; a storage portion configured to store the ink between the container portion and the ejection portion in a supply path of the ink from the container portion to the ejection portion; and a heater configured to heat the ink between the container portion and the storage portion in the supply path;
the ink supply method including:
a detection step of detecting a temperature of a location where the image forming apparatus is installed; and
a supply step of supplying the ink from the container portion to the storage portion at a supply speed based on the detected temperature detected in the detection step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an ejection portion configured to eject ink;
a container portion configured to contain the ink to be supplied to the ejection portion;
a storage portion configured to store the ink between the container portion and the ejection portion in a supply path of the ink from the container portion to the ejection portion;
a heater configured to heat the ink between the container portion and the storage portion in the supply path;
a detection processing portion configured to detect temperature of a location where the image forming apparatus is installed; and
a supply processing portion configured to supply the ink from the container portion to the storage portion at a supply speed based on the detected temperature detected by the detection processing portion.

2. The image forming apparatus according to claim 1, wherein
the supply processing portion supplies the ink from the container portion to the storage portion at a predetermined first supply speed when the detected temperature is equal to or higher than a predetermined reference temperature, and supplies the ink from the container portion to the storage portion at a second supply speed slower than the first supply speed when the detected temperature is lower than the reference temperature.

3. The image forming apparatus according to claim 2, wherein
the supply processing portion, when the detected temperature is lower than the reference temperature, supplies the ink from the container portion to the storage portion at the second supply speed based on the detected temperature.

4. The image forming apparatus according to claim 2, comprising
a formation processing portion configured to execute a formation process for forming an image on a sheet by using the ejection portion; wherein
the supply processing portion supplies the ink from the container portion to the storage portion when the remaining amount of the ink in the storage portion is less than a predetermined first amount during execution of the formation process; and
the image forming apparatus comprises a delay processing portion configured to delay formation of an image formed on the sheet when a printing rate of the image while the ink is being supplied at the second supply speed by the supply processing portion exceeds a threshold value corresponding to the second supply speed.

5. The image forming apparatus according to claim 1, comprising
a discharge processing portion configured to execute a discharge process for discharging the ink stored in the storage portion; wherein
the supply processing portion, after the discharge process is executed, supplies the ink from the container portion to the storage portion until the remaining amount of the ink in the storage portion reaches a predetermined second amount; and
the image forming apparatus comprises a notification processing portion configured to, when supply of the ink by the supply processing portion will not end before the elapsed time from start of the supply exceeds an allowable time corresponding to the supply speed, notify that the supply of the ink by the supply processing portion will not end before the elapsed time from the start of the supply exceeds the allowable time corresponding to the supply speed.

6. An ink supply method executed by an image forming apparatus comprising: an ejection portion configured to eject ink; a container portion configured to contain the ink to be supplied to the ejection portion; a storage portion configured to store the ink between the container portion and the ejection portion in a supply path of the ink from the container portion to the ejection portion; and a heater configured to heat the ink between the container portion and the storage portion in the supply path;
the ink supply method comprising:
a detection step of detecting a temperature of a location where the image forming apparatus is installed; and
a supply step of supplying the ink from the container portion to the storage portion at a supply speed based on the detected temperature detected in the detection step.
